(19) United States
(12) Patent Application Publication
(10) Pub. No.: US 2010/0138014 A1
(43) Pub. Date: Jun. 3, 2010

(54) Method for Managing A Multimedia Object Played on Multimedia Player and Multimedia Player Using the Same

(76) Inventors: Chueh-Pin Ko, Hsichih (TW); Chen-Pang Li, Hsichih (TW); Wei-Yuan Hsu, Hsichih (TW); Chao-Wei Huang, Hsichih (TW); Shih-Tang Shen, Hsichih (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/613,634

(22) Filed: Nov. 6, 2009

(30) Foreign Application Priority Data
Nov. 28, 2008 (TW) 097146411
Oct. 13, 2009 (TW) 098134664

(51) Int. Cl. G06F 17/00

(52) U.S. Cl. 700/94

(57) ABSTRACT

A method for managing a multimedia object played on a multimedia player, comprising: (A) using an electronic device to retrieve from the multimedia player for basic information related to a playing format of the multimedia player; (B): transforming a computer file into a playing file according to the basic information, wherein the playing file is in a playing format supported by the computer monitor; (C) transmitting the converted multimedia object to the multimedia player for playing or saving.

### BACKGROUND OF THE INVENTION

1. Field of the Invention

The present invention relates to a method for managing a multimedia object played on a multimedia player and multimedia player using the same.

2. Description of the Related Art

Since the modern computer monitors are replaced by the liquid crystal displays that support the direct playing of digital multimedia object, the liquid crystal display has been used as a digital photo frame for a long period of time, which increases the value of the computer monitor.

There are many products using the computer monitor as a digital photo frame, but these products substantially are display modules. Therefore, in order to use the display module as a digital photo frame, other hardware equipment such as an image processing module or multiple media playing system is needed to support the file to be played thereon. Thus, the manufacturing cost of this kind of product is increased.

Furthermore, the current multimedia objects usually have higher quality as developed with the improvement of digital camera, digital video and/or other digital audio/video/image recoding device. However, the multimedia objects obtained from these devices may have very large volume. Thus, when playing those multimedia objects on a multimedia player such as a LCD screen or a digital photo frame, it not only may cause time consumption for transmitting those multimedia files into the multimedia player, but also may cost a lot of time and resources for the multimedia player to process those files. As a result, users may feel waste time and unsmooth for the playing operation.

Therefore, it is desirable to provide a method for managing a multimedia object played on a multimedia and multimedia player using the same without increasing any extra cost on the LCD screen for supporting different formats of the multimedia objects, to mitigate and/or obviate the aforementioned problems.

### SUMMARY OF THE INVENTION

A main objective of the present invention is to provide a method for managing a multimedia object played on a multimedia player and to provide such multimedia player.

In order to achieve the above-mentioned objective, the method of the present invention comprises:

(A) using an electronic device to retrieve from the multimedia player basic information related to a playing format of the multimedia player;

(B) using the electronic device to convert the multimedia object into a format compatible with the playing format of the multimedia player according to the basic information; and

(C) transmitting the converted multimedia object to the multimedia player for playing or saving.

In one embodiment, the multimedia player can be a computer monitor or a digital photo frame, and the multimedia object can be an image file, a photo file, a video file, or a music file.

The present invention also provides a multimedia player for playing multimedia object(s). The multimedia player is communicatively connected with an electronic device. The multimedia player comprises a display module, a memory for storing basic information related to a playing format of the multimedia player, and a processor connected with the display module and the memory for processing the display of the converted multimedia object. The basic information is provided to the electronic device in order that the electronic device converts the multimedia object into a format compatible with the playing format of the multimedia player according to the basic information.

In one embodiment, the multimedia player is a computer monitor or a digital photo frame.

In further another aspect of the invention, it provides a method for managing a multimedia object played on a multimedia player, comprising: providing an electronic device connected to the multimedia player, wherein the electronic device comprises basic information related to a playing format of the multimedia player; using the electronic device to convert the multimedia object into a format compatible with the playing format of the multimedia player according to the basic information; and transmitting the converted multimedia object to the multimedia player for playing or saving.

In an embodiment, the basic information is a preloaded setting installed in the electronic device. For example, the preloaded setting is a driver or an application for the multimedia player.

Other objects, advantages, and novel features of the invention will become more apparent from the following detailed description when taken in conjunction with the accompanying drawings.

### BRIEF DESCRIPTION OF THE DRAWINGS

FIG. 1 is a perspective schematic drawing of an electronic device connected with a multimedia player according to an embodiment of the present invention.

FIG. 2 is a block drawing of a multimedia player connected to an electronic device according to an embodiment of the present invention.

FIG. 3 is a perspective schematic drawing of an electronic device and a multimedia player according to another embodiment of the present invention.

FIG. 4 is a flowchart of managing a multimedia object played on a multimedia player according to an embodiment of the present invention.

FIG. 5 is a structure schematic drawing of an electronic device executing an image display application program according to an embodiment of the present invention.

### DETAILED DESCRIPTION OF THE PREFERRED EMBODIMENT

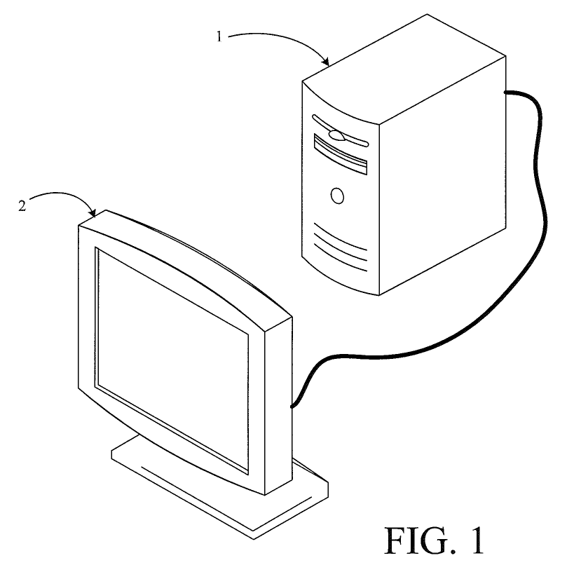

Please refer to FIG. 1, which is a perspective schematic drawing of an electronic device connected with a multimedia player according to an embodiment of the present invention. An electronic device 1 and a multimedia player 2 are electrically connected together, and the electronic device 1 enables the multimedia player 2 to have a multimedia object played thereon, which will be described more detailed below. The electronic device 1 may be of any type, such as a notebook computer, a panel computer, a palm computer, or any other portable computing device, not just the desktop computer shown in FIG. 1. In an embodiment of the invention, the multimedia player 2 can be a computer monitor such as a LCD monitor or other digital displays supporting digital format files, which are not used to limit the present invention.

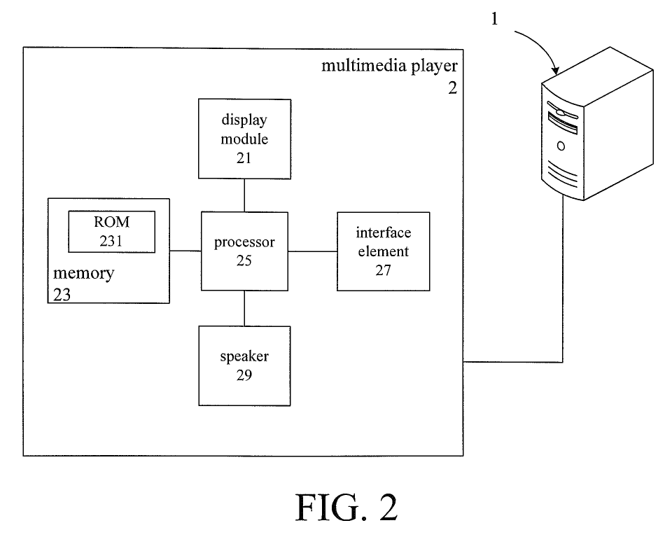

Please refer to FIG. 2 that is a block drawing of a multimedia player connected to an electronic device according to an embodiment of the present invention. A multimedia player 2 comprises a display module 21, a memory 23, an interface element 27, and a processor 25. The processor 25 is electrically connected to the memory 21, the interface element 27, and the processor 25 to execute for playing a multimedia object.

The multimedia object may be an image file, a photo file, a video file or a music file, such as an AVI file, a MPEG file, a RMVB file, a WMV file, a 3 GP file, a RW, file, a JPG file, a BMP file, a GIF file, a WAV file, an MP3 file, an MP4 file, or the like; however the present invention is limited to the above list.

In one embodiment, the memory 23 comprises read only memory 231. In this embodiment, the read only memory (ROM) 231 comprises extended display identification data (EDID) for providing basic information relating to playing format of the multimedia player 2. The electronic device 1 can retrieve the basic information from the multimedia player 2 and transform the multimedia object (such as JPG, MP3, MP4, or other media files) into a playing format (such as JPG, MP3, MP4 files compatible with the resolution or dimensions of the multimedia player 2) for the multimedia player 2 to play or to save. In one embodiment, preferably, the ROM 231 can be, but not limited to, a PROM or an EEPOM. In one embodiment of the present invention, the interface element 27 can be a VGA port so that the electronic device 1 can communicatively connect with the multimedia player 2 via, but not limited to, the VGA port to retrieve the basic information. For example, the electronic device 1 can communicatively connect with the multimedia player 2 via a HDMI port, a USB port, a DisplayPort port, or a DVI port to retrieve the basic information.

In addition, in one embodiment of the present invention, the ROM 231 can be combined within the processor 25 (not shown) to enable the processor 25 to provide the basic information related to the multimedia player 2. The basic information can be, such as, dimensions of a panel of the multimedia player 2, supporting image/audio outputting formats, speaker output power, etc. Thus, the electronic device 1 can also retrieve basic information related to the multimedia player 2 from the processor 25.

In one embodiment of the present invention, as shown in FIG. 2, the interface element 27 can not only provide a connection between the multimedia player 2 and the electronic device 1 for the transmitting of the basic information, but also provide a connection therebetween for the converted multimedia object transmitting from the electronic device 1 to the multimedia player 2 for playing or saving. For example, in an embodiment, the interface element 27 comprises a USB interface having a control chip (not shown). Alternatively, the USB interface is combined with the processor 25 to form a module (not shown) for the transmission between the electronic device 1 and the multimedia player 2. However, the present invention is not limited to the port(s) as described above for the transmission, the multimedia object can also be transmitted wirelessly, such as Bluetooth, Wi-Fi, or RF, or the like.

As shown in FIG. 2, the multimedia player 2 further comprises a speaker 29 electrically connected to the processor 25. The speaker 29 is used for playing music files or multiple media files, and the display module 21 is used for playing image files, photo files, video files, or multiple media files.

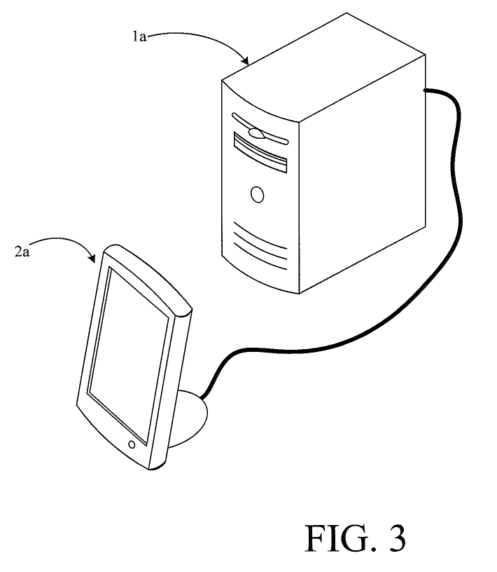

As shown in FIG. 3, in another embodiment of the present invention, the multimedia player 2a is a digital frame. The multimedia player 2a comprises a memory (such as the ROM 231 shown in FIG. 2) storing with the basic information. The electronic device 1 retrieves the basic information in the ROM 231 via the USB port, such as the interface element 27, shown in FIG. 2.

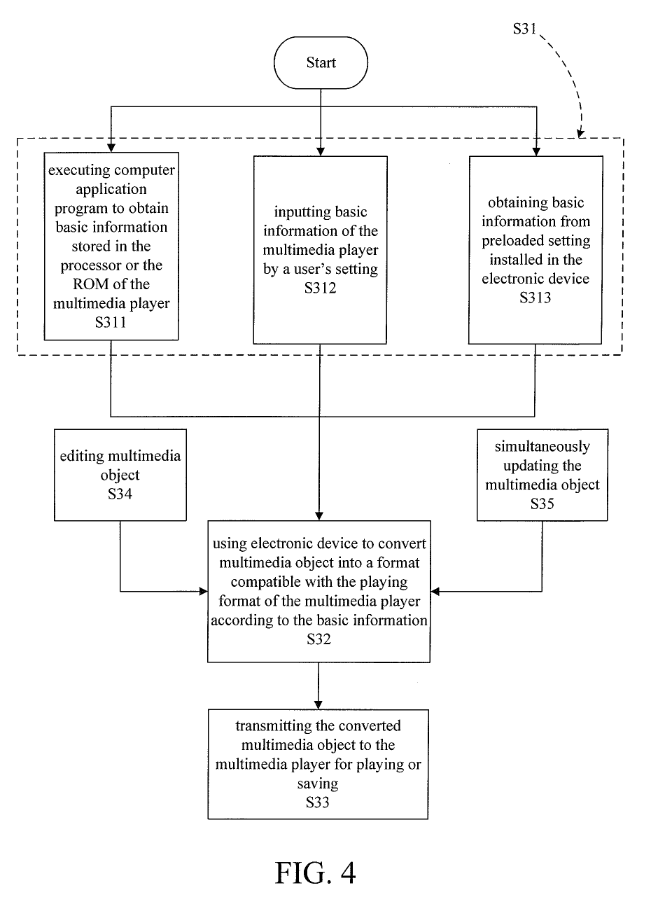

Please refer to FIG. 1, FIG. 2, and FIG. 4 at same time. Following will describe a method for managing a multimedia object played on a multimedia player in accordance with an embodiment of the present invention.

As shown in FIG. 4, the present invention provides a method for managing a multimedia object played on a multimedia player. Preferably, the method can be processed by executing an application program through an electronic device, such as the electronic device 1 shown in FIG. 1 or 2. The method comprises the following steps S31-S35.

First, to process step S31: using an electronic device to retrieve from a multimedia player for basic information related to a playing format of the multimedia player.

In an embodiment of the present invention, the basic information of the multimedia player 2 comprises, but not limited to, dimensions of a display module, the best resolution for the display module, supporting image/audio outputting formats, memory volumes, or speaker output power, etc.

In a preferred embodiment, a computer application program is executed to obtain the basic information stored in the processor 25 (such as an MCU) or the ROM 231 of the multimedia player 2 for the electronic device 1 as shown in FIG. 4 (S311). The basic information can be retrieved by many ways as described above, thus no more detailed in this embodiment.

Alternatively, in another embodiment, step S31 can be implemented by inputting basic information of the multimedia player by a user's setting (S312). In this embodiment, the electronic device 1 executes the application program to generate a user interface on the multimedia player 2 for the user to edit and select.

Further alternatively, in another embodiment, step S31 can be implemented by step S313 to obtain the basic information of the multimedia player 2. In S313, the basic information of the multimedia payer 2 is a preloaded setting installed in the electronic device. In this embodiment, the preloaded setting in the electronic device 1 is a driver or an application for the multimedia player 2.

Next, step S32: using the electronic device to convert the multimedia object into a format compatible with the playing format of the multimedia player according to the basic information.

And then, step S33: transmitting the converted multimedia object to the multimedia player for playing or saving.

In addition, the present invention allows the user to edit the playing content, the method further comprising step S34: editing the multimedia object, such as a playing sequence or other playing setting, to enable the multimedia player to play the playing file in a predetermined sequence or with a display subtitle. Preferably, the procedure of editing the multimedia object further comprises image or video editing capabilities so that the user can select or change data to increase the variety of the data of the multimedia player 2.

As shown in FIG. 4, in one another embodiment of the invention, the method of the present invention further comprises step S35: simultaneously updating the multimedia object stored in the multimedia player. In this step, a specific data folder in the memory 23 of the multimedia player 2 can be matched with another specific data folder in the electronic device 1 in order to compare for any difference in two specific data folders. Only the difference needs to be updated.

According to the method for managing a multimedia object played on a multimedia player of the present invention, the value of the multimedia player 2 can be increased. For example, when the multimedia player 2 is a computer monitor, it can be used as a digital frame to play multimedia object.

In addition, according to the method for managing a multimedia object played on a multimedia player of the present invention, the multimedia object can be pre-processed in the electronic device. Thus the processing time can be saved, which can have advantage of better performance on the multimedia player to process the multimedia object efficiently.

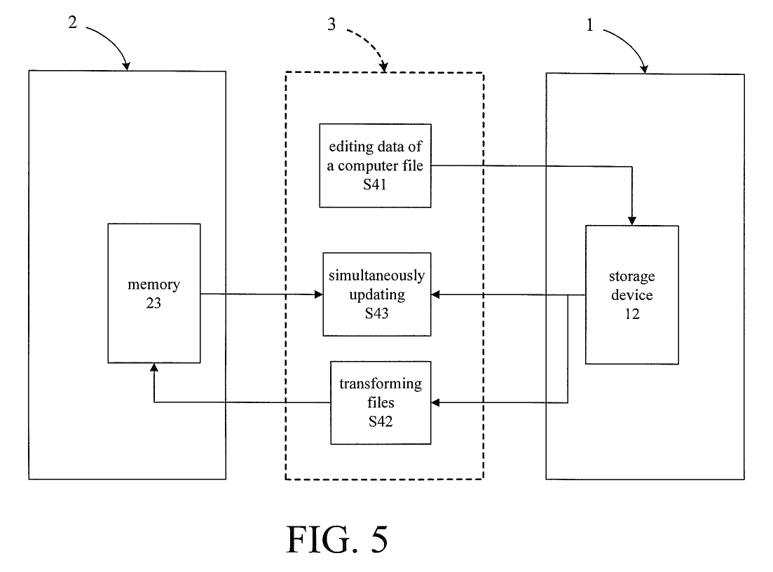

In another aspect of the present invention is to provide a displaying method by a computer system executing an application program. Please refer to FIG. 5, which is a structure schematic drawing of an electronic device executing an image display application program according to another embodiment of the present invention. An application program 3, shown in dotted lines, comprises three main operation procedures. First, in S41, the editing data of a multimedia object is transmitted to a storage device 12 of the electronic device 1, shown in the FIG. 4. Accordingly, the editing data of the multimedia object may be the basic information (such as EDID data or the screen basic information stored in the built-in processor) obtained from the multimedia player 2. Alternatively, the basic information can be format setting data inputted by the user or a preloaded setting installed in the electronic device 1. In step S42, the application program performs format transformation for the multimedia object stored in the storage device 12 of the electronic device 1; therefore, the multimedia object is transformed into a playing file supported by the multimedia player 2 based on the editing data of the multimedia object. Then the playing file is sent from the electronic device 1 to the memory 23 of the multimedia player 2 (or to be directly played by the multimedia player 2). Furthermore, in step S43, the application program 3 further comprises a data update operation procedure. The data updating operation procedure compares the two specific data folders in the storage device 12 of the electronic device 1 and the memory 23 of the multimedia player 2, respectively, to obtain the difference between the two data folders and perform data synchronization updates to synchronize the difference.

As described above, the electronic device 1 and the multimedia player 2 can be connected to have a better performance for the multimedia player 2 according to the embodiments of the present invention. Thus, the multimedia player 2 can be a general computer monitor, such as a LCD monitor or other displays supporting digital playing. The multimedia player 2 can also be a digital photo frame or the like. As shown in the embodiments of the present invention, when the electronic device 1 obtains a playing format of the multimedia player 2, it may transform a compatible multimedia object based on the playing format.

It should be noted that the basic information can be obtained from the multimedia player 2 or preloaded setting installed in the electronic device 1 for combination applications. For example, in one embodiment, the best resolution for the multimedia object is 1920×1080 and the playing format is MPEG; when any multimedia object is detected not matching the above conditions, the electronic device 1 can convert the unmatched multimedia object into a format compatible with the playing format of the multimedia player 2. The best resolution for the multimedia player comprises gamma value, contrast value, brightness value, saturation value, hue value, and skin color value etc., so as to enable the multimedia player 2 have a better playing performance; however the basic information is not limited to the above description.

The electronic device 1 can convert a multimedia object into a format compatible with the playing format of the multimedia player, which takes the advantages of: reducing the response time when the multimedia player 2 reading the multimedia object, saving the transmission time when the converted multimedia object is sent from the electronic device to the multimedia player 2, and saving the volume of the memory 23 in the multimedia player 2.

In addition, since the multimedia player has its own memory to store various transformed playing files, whether the electronic device is turned on or not, the multimedia player is capable of playing the playing files stored in the memory.

Although the present invention has been explained in relation to its preferred embodiment, it is to be understood that many other possible modifications and variations can be made without departing from the spirit and scope of the invention as hereinafter claimed.

What is claimed is:

1. A method for managing a multimedia object played on a multimedia player, comprising:
(A) using an electronic device to retrieve from the multimedia player for basic information related to a playing format of the multimedia player;
(B) using the electronic device to convert the multimedia object into a format compatible with the playing format of the multimedia player according to the basic information; and
(C) transmitting the converted multimedia object to the multimedia player for playing or saving.

2. The method as claimed in claim 1, wherein the multimedia object is selected from a group consisting of an image file, a photo file, a video file, and a music file.

3. The method as claimed in claim 1, wherein the multimedia player is a digital photo frame.

4. The method as claimed in claim 3, wherein the basic information is retrieved from a memory of the digital photo frame via a USB port connection.

5. The method as claimed in claim 1, wherein the multimedia player is a computer monitor.

6. The method as claimed in claim 5, wherein the basic information is retrieved from an extended display identification data (EDID) stored in the computer monitor via a VGA port, a Display port, or an HDMI port connection.

7. A multimedia player for playing a multimedia object, the multimedia player being communicatively connected with an electronic device and comprising:
a display module;
a memory for storing basic information related to a playing format of the multimedia player, wherein the basic information is provided to the electronic device in order that the electronic device converts the multimedia object into a format compatible with the playing format of the multimedia player according to the basic information; and
a processor used for processing the converted multimedia object to display on a panel.

8. The multimedia player as claimed in claim 7, wherein the multimedia player is a computer monitor.

9. The multimedia player as claimed in claim 8, wherein the basic information is retrieved from an EDID of the computer monitor via a VGA port, a Display port, or an HDMI port connection.

10. The multimedia player as claimed in claim 7, wherein the multimedia player is a digital photo frame.

11. The multimedia player as claimed in claim 10, wherein the basic information is retrieved from the memory via a USB port connection.

12. The multimedia player as claimed in claim 7, the multimedia object is selected from a group consisting of an image file, a photo file, a video file, and a music file.

13. A method for managing a multimedia object played on a multimedia player, comprising:
providing an electronic device connected to the multimedia player, wherein the electronic device comprises basic information related to a playing format of the multimedia player;
using the electronic device to convert the multimedia object into a format compatible with the playing format of the multimedia player according to the basic information; and
transmitting the converted multimedia object to the multimedia player for playing or saving.

14. The method as claimed in claim 13, wherein the multimedia player is a digital photo frame and the basic information is retrieved from a memory of the digital photo via a USB port connection.

15. The method as claimed in claim 13, wherein the multimedia player is a computer monitor and the basic information is retrieved from an extended display identification data (EDID) of the computer monitor via a VGA port, a Display port, or an HDMI port connection.

16. The method as claimed in claim 13, wherein the basic information is a preloaded setting installed in the electronic device.

17. The method as claimed in claim 16, wherein the preloaded setting is a driver or an application for the multimedia player.
